(19) United States
(12) Patent Application Publication
(10) Pub. No.: US 2026/0296384 A1
(43) Pub. Date: Oct. 1, 2026

(54) INTEGRATED DEVICE OF EPB LEVER AND PARKING BUTTON, AND EPB CONTROL SYSTEM AND METHOD USING SAME

(71) Applicants: Hyundai Motor Company, Seoul (KR); Kia Corporation, Seoul (KR)

(72) Inventors: Sang Won SON, Hwaseong-Si (KR); Eun Sik Kim, Hwaseong-Si (KR)

(73) Assignees: Hyundai Motor Company, Seoul (KR); Kia Corporation, Seoul (KR)

(21) Appl. No.: 19/312,021

(22) Filed: Aug. 27, 2025

(30) Foreign Application Priority Data
Mar. 31, 2025 (KR) 10-2025-0041327

(51) Int. Cl. B60T 7/10; B60T 7/08; B60T 8/17; B60T 13/74; G05G 1/01; G05G 5/04; G05G 5/05

(52) U.S. Cl. CPC B60T 7/102; B60T 7/085; B60T 8/17; B60T 13/741; G05G 1/01; G05G 5/04; G05G 5/05; B60T 2270/82; G05G 2505/00

(57) ABSTRACT

Provided are an integrated device of an EPB lever and a parking button, and an EPB control system and method using the same, in which a tiltable EPB lever and a pressable parking button are integrally provided in a single location, allowing a vehicle braking force to be easily exerted by drive control of an EPB motor for an EPB operation based on an operation of the integrated EPB lever and parking button, and by drive control of the EPB motor for the EPB operation in response to a failure of the EPB lever or the parking button.

### CROSS-REFERENCE TO RELATED APPLICATION

The present application claims under 35 U.S.C. §119(a) the benefit of Korean Patent Application No. 10-2025-0041327 filed on Mar. 31, 2025, the entire contents of which are incorporated herein by reference.

### BACKGROUND

### Technical Field

The present disclosure relates to an integrated device of an EPB lever and a parking button, and an EPB control system and method using the same, and more particularly, to an EPB control system and method in which the EPB lever and the parking button, which are separately installed in a vehicle, are integrated into a single location, and a motor for an EPB operation may be controlled using the EPB lever and the parking button arranged in a single location.

### Background Art

In general, a transmission control mechanism installed adjacent to a driver’s seat of a vehicle may include types such as a lever type, knob type, or button type. The button-type transmission control mechanism may include a parking (P) button configured to be pressed separately.

In addition, an electrical parking brake (EPB) lever for operating an electronic parking brake is mounted adjacent to the driver’s seat of the vehicle. When the EPB lever is tilted, EPB motors mounted on the left and right wheels are driven to operate a braking device, so that a braking force may be generated to maintain the vehicle in a stationary state.

As described above, since the parking button and the EPB lever are separately installed adjacent to the driver's seat in the vehicle, the driver may easily distinguish between the positions of the parking button and the EPB lever during emergency braking. However, this leads to an increase in the number of components, reduced space around the driver's seat, and insufficient installation space for other convenient components.

In some vehicle models currently on the market, a logic is applied where the EPB operates when the parking button is pressed for a certain duration, rather than installing a separate EPB lever or EPB button.

Accordingly, there is an issue in which drivers who are unaware of the method of EPB operation, that is, the method of pressing the parking button for a certain duration to operate the EPB, may fail to operate the EPB when emergency braking is required, leading to a vehicle accident.

### SUMMARY OF THE DISCLOSURE

Various embodiments are directed to providing an integrated device of an EPB lever and a parking button, and an EPB control system and method using the same, in which a tiltable EPB lever and a pressable parking button are integrally disposed in a single location, allowing a vehicle braking force to be easily exerted by drive control of an EPB motor for an EPB operation based on an operation of the integrated EPB lever and parking button, and by drive control of the EPB motor for the EPB operation in response to a failure of the EPB lever or the parking button.

In an exemplary embodiment of the present disclosure, an integrated device of an EPB lever and a parking button includes a first housing guiding a vertical movement of the parking button, the parking button pressably disposed on the first housing, a first magnetic body disposed on at least one side of first and second sides of the parking button, a second housing spaced apart around a peripheral portion of the first housing and configured to pivot the EPB lever, the EPB lever operatively disposed on the second housing and disposed around an upper peripheral portion of the parking button, a second magnetic body disposed on at least one side of first and second sides of the EPB lever, and a printed circuit board (PCB) disposed on a lower portion of the first housing and configured to detect an operation of the parking button by a downward movement of the first magnetic body and detect an operation of the EPB lever by a pivotal movement of the second magnetic body.

In an exemplary embodiment of the present disclosure, the first housing includes a base plate of a predetermined area, a case disposed on an upper surface of the base plate and configured with an open upper structure into which the parking button is inserted vertically, and a guide plate disposed on the upper surface of the base plate, on first and second sides of the case, and having guide holes extending in a vertical direction.

A stopper disposed on at least one side of first and second sides of a lower portion of the parking button, is configured to be inserted into the guide hole of the guide plate vertically and is including the first magnetic body.

At least one first spring is connected between a lower surface of the parking button and the base plate, which is compressed in response to a downward movement of the parking button.

Hinge grooves are formed on both sides of an upper portion of the second housing to allow the EPB lever to be pivotably mounted.

In an exemplary embodiment of the present disclosure, the EPB lever includes a rectangular frame-shaped lever, including an operation bar disposed at a front position of the parking button and a push bar disposed to be in contact with a rear upper surface of the parking button, and a pivot bar extending downwardly from at least one side of first and second sides of the lever, configured to be pivotably inserted into the hinge groove in a forward and backward direction, and including the second magnetic body.

A second spring is connected between an upper portion of the pivot bar and the hinge groove to provide an elastic restoring force in response to the pivoting of the EPB lever.

Based on an upward operation of the operation bar of the EPB lever, the push bar presses the upper surface of the parking button, which limits a rotation angle of the EPB lever in an operation direction according to a pressing distance of the parking button, and based on an downward operation of the operation bar of the EPB lever, an internal surface of the operation bar comes into contact with a front portion of the parking button, which limits a rotation angle of the EPB lever in an operation release direction thereof.

In an exemplary embodiment of the present disclosure, the PCB includes a first PCB having a Hall sensor which is configured to detect a magnetic force based on a downward movement of the first magnetic body and outputs an operation signal of the parking button, and a second PCB having a Hall sensor which is configured to detect a magnetic force based on a pivotal movement of the second magnetic body and outputs an operation signal or operation release signal of the EPB lever.

In an exemplary embodiment of the present disclosure, the integrated device of the EPB lever and the parking button further includes a lower cover covering a lower surface of the first housing and a peripheral portion of the second housing, and an upper cover disposed on the lower cover and configured with an opening to operatively expose the parking button and the EPB lever externally.

In another embodiment of the present disclosure, an EPB control system includes a parking button pressably disposed on a first housing and including a first magnetic body mounted on at least one side of first and second sides thereof, an EPB lever operatively disposed on a second housing spaced apart around a peripheral portion of the first housing, disposed around an upper peripheral portion of the parking button, and include a second magnetic body disposed on at least one side of first and second sides thereof, a PCB disposed on a lower portion of the first housing and configured to detect an operation of the parking button by a downward movement of the first magnetic body and detect an operation of the EPB lever by a pivotal movement of the second magnetic body, a second controller configured to receive an operation signal of the parking button and an operation signal of the EPB lever from the PCB and perform control to drive an EPB motor for an EPB braking operation, and a first controller configured to receive an operation signal of the parking button and an operation signal of the EPB lever from the PCB, and perform control to drive the EPB motor for the EPB braking operation, in preparation for a failure of the second controller.

In another embodiment of the present disclosure, the PCB includes a first PCB having a Hall sensor which is configured to detect a magnetic force based on a downward movement of the first magnetic body and outputs an operation signal of the parking button to the first controller and the second controller, and a second PCB having a Hall sensor which is configured to detect a magnetic force based on a pivotal movement of the second magnetic body and outputs an operation signal or operation release signal of the EPB lever to the first controller and the second controller.

In another embodiment of the present disclosure, the second controller is configured to perform control to drive the EPB motor with a first torque based on receiving the operation signal of the EPB lever from the PCB, and to perform control to drive the EPB motor with a second torque lower than the first torque based on receiving the operation signal of the parking button from the PCB.

In another embodiment of the present disclosure, the second controller is configured to perform control to drive the EPB motor with the first torque based on the operation signal of the EPB lever in response to a failure of the parking button and a first PCB, and to perform control to drive the EPB motor with the second torque lower than the first torque based on the operation signal of the parking button in response to a failure of the EPB lever or the second PCB.

In another embodiment of the present disclosure, the EPB control system further includes a third controller configured to either receive a control signal for driving the EPB motor based on the operation signal of the EPB lever from the first controller and perform control to drive a left-wheel EPB motor with a first torque, or receive a control signal for driving the EPB motor based on the operation signal of the parking button and perform control to drive the left-wheel EPB motor with a second torque lower than the first torque, and a fourth controller configured to either receive a control signal for driving the EPB motor based on the operation signal of the EPB lever from the first controller and perform control to drive a right-wheel EPB motor with the first torque, or receive a control signal for driving the EPB motor based on the operation signal of the parking button and perform control to drive the right-wheel EPB motor with the second torque lower than the first torque.

In yet another embodiment of the present disclosure, an EPB control method includes pressing a parking button including a first magnetic body, or tilting an EPB lever including a second magnetic body in an operation direction or operation release direction, detecting, by a PCB, an operation of the parking button by a downward movement of the first magnetic body, detecting, by the PCB, an operation of the EPB lever by a pivotal movement of the second magnetic body, receiving, by a second controller, an operation signal of the parking button and an operation signal of the EPB lever from the PCB, and performing control to drive an EPB motor for an EPB braking operation, and receiving, by a first controller, an operation signal of the parking button and an operation signal of the EPB lever from the PCB, and performing control to drive the EPB motor for the EPB braking operation, in preparation for a failure of the second controller.

In yet another embodiment of the present disclosure, the PCB detects the operation of the parking button by detecting a magnetic force based on the downward movement of the first magnetic body and outputs the operation signal of the parking button to the first controller and the second controller, and detects the operation of the EPB lever by detecting a magnetic force based on the pivotal movement of the second magnetic body and outputs the operation signal or operation release signal of the EPB lever to the first controller and the second controller.

In yet another embodiment of the present disclosure, the second controller is configured to perform control to drive the EPB motor with a first torque based on receiving the operation signal of the EPB lever from the PCB, and to perform control to drive the EPB motor with a second torque lower than the first torque based on receiving the operation signal of the parking button from the PCB.

In yet another embodiment of the present disclosure, the second controller is configured to perform control to drive the EPB motor with the first torque based on the operation signal of the EPB lever in response to a failure of the parking button and a first PCB, and to perform control to drive the EPB motor with the second torque lower than the first torque based on the operation signal of the parking button in response to a failure of the EPB lever or the second PCB.

In yet another embodiment of the present disclosure, the EPB control method further includes performing control, by a third controller, to drive a left-wheel EPB motor with a first torque by receiving a control signal for driving the EPB motor based on the operation signal of the EPB lever from the first controller, or performing control, by the third controller, to drive the left-wheel EPB motor with a second torque lower than the first torque by receiving a control signal for driving the EPB motor based on the operation signal of the parking button, and performing control, by a fourth controller, to drive a right-wheel EPB motor with the first torque by receiving a control signal for driving the EPB motor based on the operation signal of the EPB lever from the first controller, or performing control, by the fourth controller, to drive the right-wheel EPB motor with the second torque lower than the first torque by receiving a control signal for driving the EPB motor based on the operation signal of the parking button.

Through the above-described solution, the present disclosure provides the following effects.

First, the integration of the tiltable EPB lever and the pressable parking button in a single location allows for a reduction in the number of components and costs, and ensuring additional packaging space around the driver's seat for installing other convenience components.

Second, the integral arrangement of the EPB lever and the parking button in a single location is advantageous for the driver’s recognition of the location. Accordingly, when emergency braking is required, the driver may easily operate the EPB lever to brake the vehicle.

Third, in response to a failure of the second controller that controls the drive of the EPB motor for the EPB braking operation, the first controller is configured to perform the drive control of the EPB motor, allowing for easy braking or parking of the vehicle.

Fourth, in response to a failure of the parking button or the first PCB, the EPB motor is driven with a predetermined torque for the EPB braking operation. Similarly, in response to a failure of the EPB lever or the second PCB, the EPB motor is driven with a predetermined torque, allowing for easy braking or parking of the vehicle.

### BRIEF DESCRIPTION OF THE DRAWINGS

FIG. 1 is an exploded perspective view exemplarily illustrating an integrated device of an EPB lever and a parking button according to an exemplary embodiment of the present disclosure.

FIGS. 2 and 3 are perspective views exemplarily illustrating structures of the EPB lever, the parking button, and a first housing in a configuration of the integrated device of the EPB lever and the parking button according to an exemplary embodiment of the present disclosure.

FIG. 4 is a perspective view exemplarily illustrating a state in which a second housing, to which the EPB lever is hinged, is inserted into a lower cover in the configuration of the integrated device of the EPB lever and the parking button according to an exemplary embodiment of the present disclosure.

FIG. 5 is a perspective view exemplarily illustrating a completely assembled state of the integrated device of the EPB lever and the parking button according to an exemplary embodiment of the present disclosure.

FIGS. 6 and 7 are a lateral sectional perspective view and a sectional view of the integrated device of the EPB lever and the parking button according to an exemplary embodiment of the present disclosure.

FIGS. 8 and 9 are a longitudinal sectional perspective view and a sectional view of the integrated device of the EPB lever and the parking button according to an exemplary embodiment of the present disclosure.

FIG. 10 is a side view exemplarily illustrating the pressed state of the parking button in the configuration of the integrated device of the EPB lever and the parking button according to an exemplary embodiment of the present disclosure.

FIG. 11 is a side view exemplarily illustrating a state in which the EPB lever is pivoted in the release direction in the configuration of the integrated device of the EPB lever and the parking button according to an exemplary embodiment of the present disclosure.

FIG. 12 is a side view exemplarily illustrating a state in which the EPB lever is pivoted in the operation direction and the parking button is pressed by the EPB lever in the configuration of the integrated device of the EPB lever and the parking button according to an exemplary embodiment of the present disclosure.

FIG. 13 is a control block diagram of an EPB control system and method according to an exemplary embodiment of the present disclosure.

FIG. 14 is a control block diagram illustrating a drive control process for an EPB motor in response to a failure of a first controller in the EPB control system and method according to an exemplary embodiment of the present disclosure.

FIG. 15 is a control block diagram illustrating a drive control process for the EPB motor in response to a failure of a second controller in the EPB control system and method according to an exemplary embodiment of the present disclosure.

### DETAILED DESCRIPTION

The specific structural or functional descriptions provided in embodiments of the present specification are merely illustrative, intended to describe the embodiments according to the concept of the present disclosure. The embodiments according to the concept of the present disclosure may be implemented in various forms and should not be interpreted as limited by the embodiments described in the present specification, but should be understood to include all modifications, equivalents, or substitutes within the spirit and technical scope of the present disclosure.

Terms such as first and/or second used in the present specification may be used to describe various components, but the components are not limited by these terms. The terms are used solely for distinguishing one component from another component. For example, without departing from the scope of the claims according to the concept of the present disclosure, a first component may be referred to as a second component, and similarly, the second component may also be referred to as the first component.

When a component is referred to as being “connected” or “coupled” to another component, the component may be directly connected or coupled to another component, but it should be understood that sill another component may be present between the component and another component. Conversely, when a component is referred to as being “directly connected” or “directly coupled” to another component, it should be understood that still another component may not be present between the component and another component. Other expressions, that is, "between" and "just between" or "adjacent to" and "directly adjacent to", for describing a relationship between components, should be interpreted in a similar manner.

Like reference numerals indicate like components throughout the present specification. Terms used in the present specification are used for describing embodiments, not limiting the present disclosure. Unless stated otherwise in the present specification a singular form also includes a plural form. The terms "comprise" and/or "comprising" used in the specification do not exclude the presence or addition of one or more other components, steps, operations, and/or elements beyond those described.

Various exemplary embodiments of the present disclosure will be described in detail below with reference to the accompanying drawings.

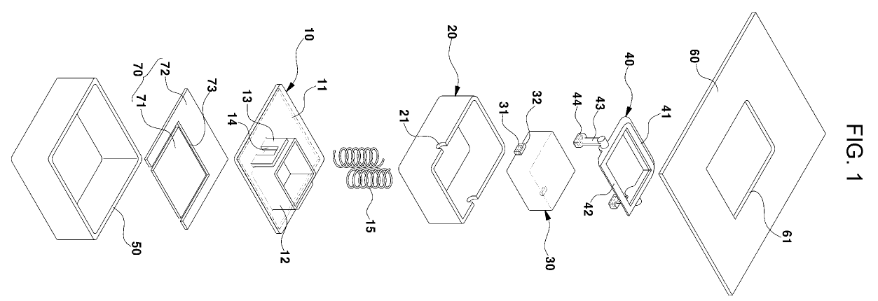

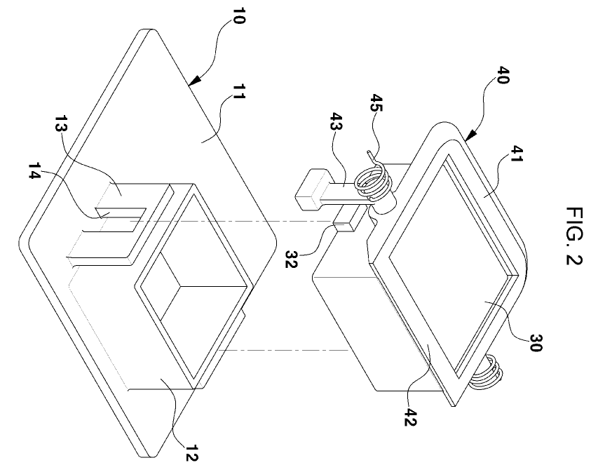

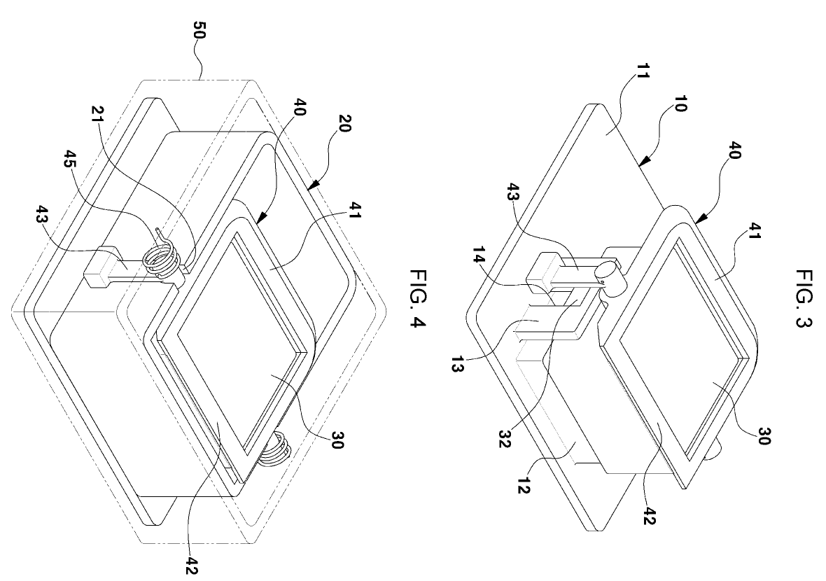

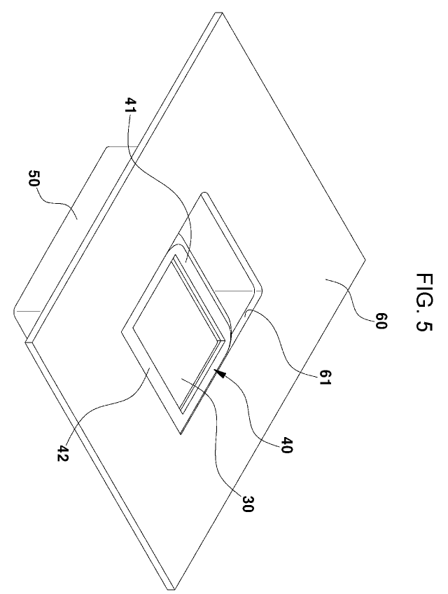

Attached FIGS. 1 to 5 are perspective views exemplarily illustrating an integrated device of an electrical parking brake (EPB)lever and a parking button according to an exemplary embodiment of the present disclosure.

As illustrated in FIGS. 1 to 5, a parking button 30 is disposed in a form of a rectangular block including a hollow internal and an open lower surface, and is pressably disposed on the first housing 10.

Stopper(s) 32 may be formed to protrude on both sides of the lower portion of the parking button 30 to limit an upward travel distance, and a first magnetic body 31 is mounted on the stopper 32. The first magnetic body 31 may be a permanent magnet or an electromagnet exerting a magnetic force.

The first housing 10 includes a base plate 11 of a predetermined area, a case 12 formed on an upper surface of the base plate 11, and guide plates 13 formed on the upper surface of the base plate 11 and disposed on both sides of the case 12.

The case 12 is formed with an open-top structure into which the parking button 30 may be inserted vertically, and the guide plates 13 are formed with guide holes 14 that extend in the vertical direction.

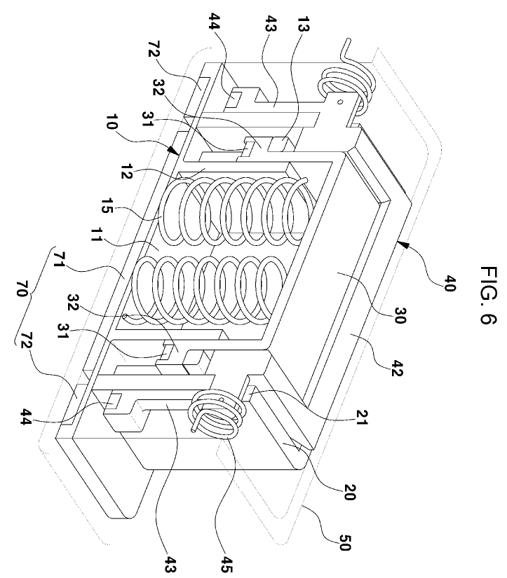

As shown in FIGS. 6 and 7, the first magnetic body 31 may be mounted on a lower surface of the stopper 32. Between the lower surface of the parking button 30 and the base plate 11 forming the bottom portion of the case 12, at least one first spring 15 is connected, which is compressed in response to the downward movement of the parking button 30.

Therefore, in a state where the stoppers 32, formed on both sides of the lower portion of the parking button 30, are inserted into the guide holes 14 of the guide plate 13 vertically, pressing the parking button 30 compresses the first spring 15, and releasing pressure on the parking button 30 allows the parking button 30 to rise back to the original position due to the elastic restoring force of the first spring 15.

For example, in response to the upward movement of the parking button 30, the stopper 32 engages with an upper end portion of the guide hole 14 of the guide plate 13, thus limiting the upward travel distance of the parking button 30.

A second housing 20 is spaced apart around a peripheral portion of the first housing 10, and hinge grooves 21 are formed on both sides of the upper portion of the present second housing 20 to allow an EPB lever 40 to be pivotably mounted.

The EPB lever 40 is mounted in the hinge groove 21 of the second housing 20 to be tilted like a seesaw, and is disposed around an upper peripheral portion of the parking button 30.

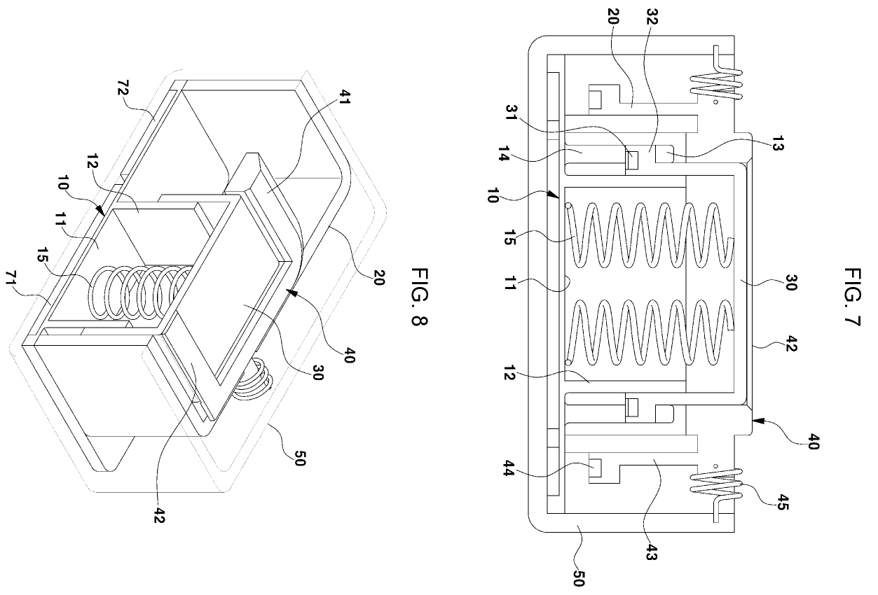

To the present end, as shown in FIGS. 8 and 9, the EPB lever 40 may include a rectangular frame shape, including an operation bar 41 disposed at a front position of the parking button 30, and a push bar 42 disposed to be in contact with a rear upper surface of the parking button 30.

Furthermore, as shown in FIGS. 6 and 7, a pivot bar 43 is formed to extend downward on both sides of the EPB lever 40. An upper end portion of the present pivot bar 43 is pivotably mounted in the hinge groove 21 of the second housing 20, and a second magnetic body 44 is mounted on a lower end portion of the pivot bar 43. The second magnetic body 44 may be a permanent magnet or an electromagnet exerting a magnetic force.

For example, a second spring 45, twisted and compressed in response to the pivoting of the EPB lever 40, is connected between the upper end portion of the pivot bar 43 and the hinge groove 21. Accordingly, when the operation bar 41 is tilted upward or downward, the EPB lever 40 pivots, and the EPB lever 40 may return to the original position due to the elastic restoring force of the second spring 45.

The lower surface of the first housing 10 and the peripheral portion of the second housing 20 may be covered and protected by a lower cover 50. The upper portions of the first housing 10 and second housing 20 may be covered and protected by an upper cover 60. An opening 61 is formed in the upper cover 60 to expose the parking button 30 and the EPB lever 40 to the outside thereof, allowing user operation.

A printed circuit board (PCB) 70 is mounted on a lower portion of the first housing 10 to detect the pressed operation of the parking button 30 by a downward movement of the first magnetic body 31, and to detect the tilting operation, that is, the pivotal operation of the EPB lever 40 by a pivotal movement of the second magnetic body 44.

To the present end, as shown in FIGS. 1, 6, and 7, the PCB 70 may include a first PCB 71 including a Hall sensor which is configured to detect the downward movement of the first magnetic body 31 and outputs an operation signal of the parking button 30, and a second PCB 72 including a Hall sensor which is configured to detect the pivotal movement of the second magnetic body 44 and outputs an operation or operation release signal of the EPB lever 40.

For example, an arrangement groove 73 may be formed on one side of the second PCB 72, and the first PCB 71 may be inserted and disposed within the present arrangement groove 73.

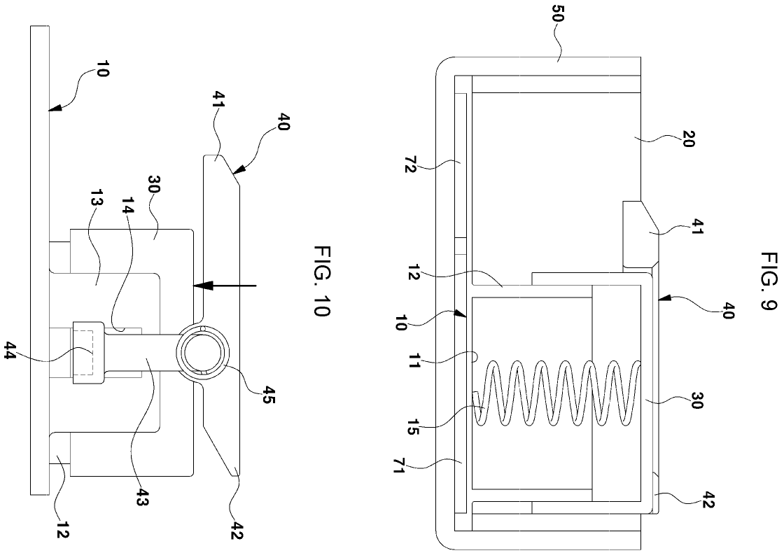

Referring to FIG. 10, as the user presses the parking button 30, the parking button 30 moves downward, and the first magnetic body 31 also moves downward to approach the first PCB 71, allowing the Hall sensor of the first PCB 71 to detect the magnetic force of the first magnetic body 31. Accordingly, the first PCB 71 may recognize that the parking button 30 is pressed and output an operation signal of the parking button 30.

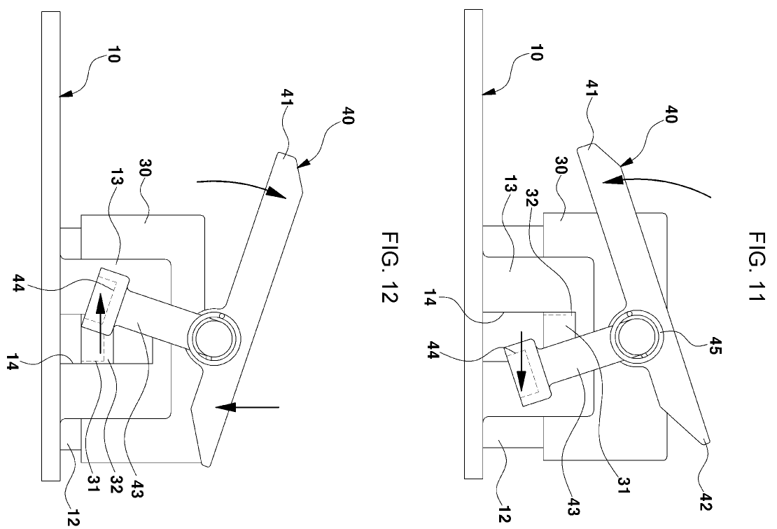

Referring to FIG. 11, as the user presses the operation bar 41 of the EPB lever 40 downward, the operation bar 41 pivots downward, the pivot bar 43 pivots rearward, and the second magnetic body 44, mounted on the lower portion of the pivot bar 43, also pivots rearward, allowing the Hall sensor of the second PCB 72 to detect the magnetic force of the second magnetic body 44. Accordingly, the second PCB 72 may recognize that the EPB lever 40 is operated in the operation release direction and output an operation release signal of the EPB lever 40.

For example, when the operation bar 41 of the EPB lever 40 is tilted downward, that is, when the operation bar 41 is pressed downward, the internal surface of the operation bar 41 may come into contact with a front portion of the parking button 30. As a result, a rotation angle of the EPB lever 40 in the operation release direction may be limited.

Referring to FIG. 12, as the user tilts the operation bar 41 of the EPB lever 40 upward, the operation bar 41 pivots downward, the pivot bar 43 pivots forward, and the second magnetic body 44, mounted on the lower portion of the pivot bar 43, also pivots forward, allowing the Hall sensor of the second PCB 72 to detect the magnetic force of the second magnetic body 44. Accordingly, the second PCB 72 may recognize that the EPB lever 40 is operated in the operation direction and output an operation signal of the EPB lever 40.

As the user tilts the operation bar 41 of the EPB lever 40 upward, the operation bar 41 may pivot upward, and the push bar 42 may pivot downward, allowing the parking button 30 to be pressed.

For example, when the operation bar 41 of the EPB lever 40 is tilted upward, the push bar 42 may press the upper surface of the parking button 30. As a result, the rotation angle of the EPB lever 40 in the operation direction may be limited according to the pressing distance of the parking button 30.

As described above, the reason for configuring the parking button 30 to be simultaneously pressed by the push bar 42 in response to the tilting operation of the EPB lever 40 is to prepare for a failure of the parking button 30 or the first PCB 71, and a failure of the EPB lever 40 or the second PCB 72.

The reason for configuring the parking button 30 to be simultaneously pressed in response to the tilting operation of the EPB lever 40 is that, in response to a failure of the parking button 30 or the first PCB 71, an EPB motor for EPB braking may be driven based on an operation signal of the EPB lever 40. Similarly, in response to a failure of the EPB lever 40 or the second PCB 72, the EPB motor for EPB braking may be driven based on an operation signal of the parking button 30. This may enhance the braking stability of the vehicle in an emergency.

For example, in response to a failure of the parking button 30 or the first PCB 71, the EPB motor for EPB braking may be driven by a controller based on the operation signal of the EPB lever 40 in response to the tilting operation of the EPB lever 40, allowing for safe braking and parking of the vehicle.

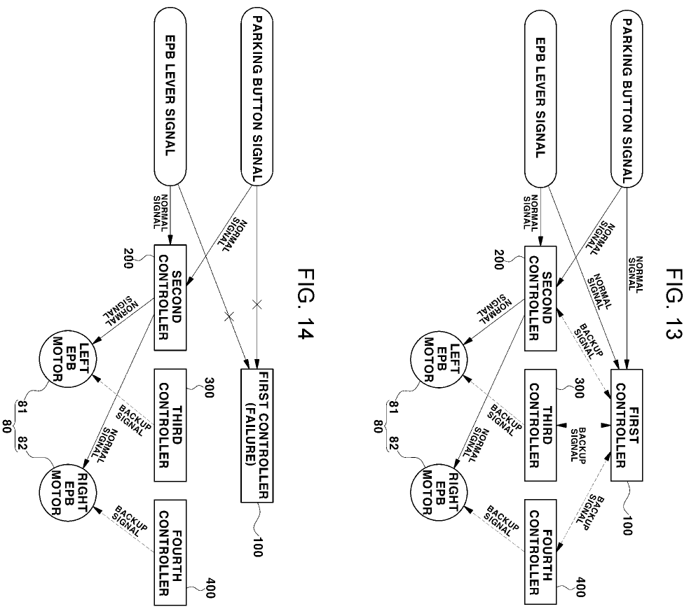

The attached FIGS. 13, 14, and 15, are control block diagrams for an EPB control system and method according to an exemplary embodiment of the present disclosure.

The EPB control system according to an exemplary embodiment of the present disclosure includes a first controller and a second controller, in addition to the components included in the integrated device of the EPB lever and the parking button described above.

The first controller 100 may be a vehicle controller, which is the highest-level controller of the vehicle, and the second controller 200 may be a brake controller for controlling an integrated electric brake (IEB).

The second controller 200 is configured to receive an operation signal of the parking button 30 from the first PCB 71 of the PCB 70 or an operation signal of the EPB lever 40 from the second PCB 72, and to perform control to drive an EPB motor 80 for an EPB braking operation.

Accordingly, when the EPB motor is driven based on a control signal from the second controller 200, the braking operation may be performed as brake pads come into close contact with the disc by the driving of the EPB motor, as is well known.

Furthermore, the second controller 200 is configured to perform control to drive the EPB motor 80 with a first torque based on an operation signal of the EPB lever 40 received from the second PCB 72 of the PCB 70, and to perform control to drive the EPB motor 80 with a second torque lower than the first torque based on an operation signal of the parking button 30 received from the first PCB 71 of the PCB 70.

The reason the second controller 200 performs control to drive the EPB motor with the first torque higher than the second torque based on the operation signal of the EPB lever 40 received from the second PCB 72 is that the parking requires a braking force to exclusively maintain the stationary state of the vehicle, but the EPB needs to exert a braking force required for emergency braking.

Furthermore, the reason the second torque for the parking braking operation of the EPB motor is set lower than the first torque is to reduce the operating load on the EPB motor and improve durability performance.

Furthermore, the second controller 200 is configured to perform control to drive the EPB motor 80 with the first torque based on the operation signal of the EPB lever in response to a failure of the parking button 30 or the first PCB 71. On the other hand, in response to a failure of the EPB lever 40 or the second PCB 72, the second controller 200 is configured to perform control to drive the EPB motor 80 with the second torque lower than the first torque, based on the operation signal of the parking button.

When the EPB lever 40 is tilted, the parking button 30 is simultaneously pressed. Accordingly, in response to a failure of the parking button 30 or the first PCB 71, the second controller 200 is configured to perform control to drive the EPB motor for EPB braking with the first torque based on the operation signal of the EPB lever 40. On the other hand, in response to a failure of the EPB lever 40 or the second PCB 72, the second controller 200 is configured to perform control to drive the EPB motor for EPB braking with the second torque lower than the first torque, based on the operation signal of the parking button 30. Accordingly, when braking is required for the vehicle, the EPB motor may be driven with either the first or second torque, allowing for safe braking and parking of the vehicle.

The first controller 100 is configured to perform control to drive the EPB motor 80 for the EPB braking operation by receiving the operation signal of the parking button 30 from the first PCB 71 of the PCB 70 or the operation signal of the EPB lever 40 from the second PCB 72, in preparation for a failure of the second controller 200.

For example, in response to a failure of the second controller 200, the first controller 100 may receive the operation signal of the parking button 30 from the first PCB 71 or the operation signal of the EPB lever 40 from the second PCB 72, and issue command signals to drive the EPB motor to a third controller 300, which is one of the other subordinate controllers mounted in the vehicle, or a fourth controller 400, which is another subordinate controller.

To the present end, the third controller 300 may be configured to either receive a control signal for driving the EPB motor based on the operation signal of the EPB lever 40 from the first controller 100 and perform control to drive a left-wheel EPB motor 81 with the first torque, or receive a control signal for driving the EPB motor based on the operation signal of the parking button 30 and perform control to drive the left-wheel EPB motor 81 with the second torque lower than the first torque.

Furthermore, the fourth controller 400 may be configured to either receive a control signal for driving the EPB motor based on the operation signal of the EPB lever 40 from the first controller 100 and perform control to drive a right-wheel EPB motor 82 with the first torque, or receive a control signal for driving the EPB motor based on the operation signal of the parking button 30 and perform control to drive the right-wheel EPB motor 82 with the second torque lower than the first torque.

An EPB control method according to an exemplary embodiment of the present disclosure will be described hereinafter in order as follows.

First, as shown in FIG. 10, as the user exclusively presses the parking button 30 on which the first magnetic body 31 is mounted, the parking button 30 moves downward, and the first magnetic body 31 also moves downward to approach the first PCB 71, allowing the Hall sensor of the first PCB 71 to detect the magnetic force of the first magnetic body 31. Accordingly, the first PCB 71 may recognize that the parking button 30 is pressed and output an operation signal of the parking button 30 to the first controller 100 and the second controller 200.

Alternatively, as shown in FIG. 11, as the user tilts the EPB lever 40 on which the second magnetic body 44 is mounted in the release direction, that is, as the user presses the operation bar 41 of the EPB lever 40 downward, the operation bar 41 pivots downward, the pivot bar 43 pivots rearward thereof, and the second magnetic body 44, mounted on the lower portion of the pivot bar 43, also pivots rearward thereof, allowing the Hall sensor of the second PCB 72 to detect the magnetic force of the second magnetic body 44. Accordingly, the second PCB 72 may recognize that the EPB lever 40 is operated in the operation release direction and output an operation release signal of the EPB lever 40 to the first controller 100 and the second controller 200.

Alternatively, as shown in FIG. 12, as the user tilts the EPB lever 40 on which the second magnetic body 44 is mounted in the operation direction, that is, as the user tilts the operation bar 41 of the EPB lever 40 upward, the operation bar 41 pivots upward, the pivot bar 43 pivots forward, and the second magnetic body 44, mounted on the lower portion of the pivot bar 43, also pivots forward, allowing the Hall sensor of the second PCB 72 to detect the magnetic force of the second magnetic body 44. Accordingly, the second PCB 72 may recognize that the EPB lever 40 is operated in the operation direction and output an operation signal of the EPB lever 40 to the first controller 100 and the second controller 200.

Referring to FIG. 13, when the first controller 100 and the second controller 200 are in a normal state, the second controller 200 may normally receive the operation signal of the parking button 30 and the operation signal of the EPB lever 40 from the PCB 70, and perform control to drive the EPB motor for the EPB braking operation.

In other words, the second controller 200 may perform control to drive the EPB motor 80 with the first torque based on the operation signal of the EPB lever 40 received from the second PCB 72, or may perform control to drive the EPB motor 80 with the second torque lower than the first torque based on the operation signal of the parking button 30 received from the first PCB 71, allowing the vehicle to be stopped and braked in an emergency.

Furthermore, the second controller 200 may perform control to drive the EPB motor 80 with the first torque based on the operation signal of the EPB lever 40 in response to a failure of the parking button 30 or the first PCB 71, and may perform control to drive the EPB motor 80 with the second torque lower than the first torque, based on the operation signal of the parking button 30 in response to a failure of the EPB lever 40 or the second PCB 72.

As described above, when the EPB lever 40 is tilted, the parking button 30 is simultaneously pressed. Accordingly, the second controller 200 may perform control to drive the EPB motor for EPB braking based on the operation signal of the EPB lever 40 in response to a failure of the parking button 30 or the first PCB 71, or may perform control to drive the EPB motor for EPB braking based on the operation signal of the parking button 30 in response to a failure of the EPB lever 40 or the second PCB 72. As a result, the EPB motor may be driven by control of the first torque or the second torque to perform EPB braking, and accordingly, ensure braking stability of the vehicle in an emergency.

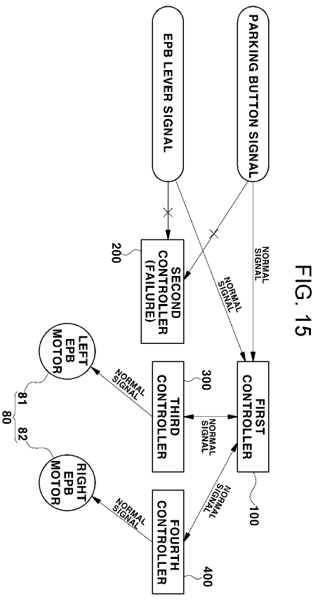

Referring to FIG. 14, when the second controller 200 is in a normal state and the first controller 100 has a failure, the operation signal of the parking button 30 may not be transmitted from the first PCB 71 to the first controller 100, and the operation signal of the EPB lever 40 may not be transmitted from the second PCB 72 to the first controller 100. However, the operation signals of the parking button 30 and the EPB lever 40 may be normally output to the second controller 200.

Accordingly, based on the operation signals of the parking button 30 and the EPB lever 40 from the second controller 200, control may be performed to drive the EPB motor for the EPB braking operation as described above.

For example, when the second controller 200 notifies a different controller of the failure state of the first controller 100, a warning light on the cluster is illuminated by that controller, allowing the user to recognize the failure state of the first controller 100 and take follow-up actions.

Referring to FIG. 15, based on a normal state of the first controller 100 and a failure state of the second controller 200, the first controller 100 may, in preparation for a failure of the second controller 200, normally receive an operation signal of the parking button 30 from the first PCB 71, or may normally receive an operation signal of the EPB lever 40 from the second PCB 72, and perform control to drive the EPB motor 80 for the EPB braking operation.

For example, in response to a failure of the second controller 200, the first controller 100 may receive the operation signal of the parking button 30 from the first PCB 71 or the operation signal of the EPB lever 40 from the second PCB 72, and issue command signals to drive the EPB motor to the third controller 300, which is one of the other subordinate controllers mounted in the vehicle, or the fourth controller 400, which is another subordinate controller.

Accordingly, the third controller 300 may receive a control signal for driving the EPB motor based on the operation signal of the EPB lever 40 from the first controller 100 and perform control to drive the left-wheel EPB motor 81 with the first torque, and the fourth controller 400 may receive a control signal for driving the EPB motor based on the operation signal of the EPB lever 40 from the first controller 100 and perform control to drive the right-wheel EPB motor 82 with the first torque, allowing for easy braking and parking of the vehicle.

Alternatively, the third controller 300 may receive a control signal for driving the EPB motor based on the operation signal of the parking button 30 from the first controller 100 and perform control to drive the left-wheel EPB motor 81 with the second torque lower than the first torque, and the fourth controller 400 may receive a control signal for driving the EPB motor based on the operation signal of the parking button 30 from the first controller 100 and perform control to drive the right-wheel EPB motor 82 with the second torque lower than the first torque, allowing for easy braking and parking of the vehicle.

As described above, since the EPB lever 40 and the parking button 30 are integrally disposed in a single location, it is intuitive and convenient for the driver to recognize the location. Accordingly, when emergency braking is required, the driver may easily operate the EPB lever 40 or the parking button 30, allowing for easy braking and parking of the vehicle.

Although the present disclosure has been described in detail with reference to an exemplary embodiment of the present disclosure, the scope of the present disclosure is not limited to the exemplary embodiment described above. Various modifications and improvements made by those skilled in the art, based on the basic concept of the present disclosure as defined in the claims below, also fall within the scope of the present disclosure.

What is claimed is:

1. An integrated device of an electrical parking brake (EPB) lever and a parking button, the integrated device comprising:
a first housing guiding a vertical movement of the parking button, the parking button pressably disposed on the first housing;
a first magnetic body disposed on at least one side of first and second sides of the parking button;
a second housing spaced apart around a peripheral portion of the first housing and configured to pivot the EPB lever, the EPB lever operatively disposed on the second housing and disposed around an upper peripheral portion of the parking button;
a second magnetic body disposed on at least one side of first and second sides of the EPB lever; and
a printed circuit board (PCB) disposed on a lower portion of the first housing and configured to detect an operation of the parking button by a downward movement of the first magnetic body and detect an operation of the EPB lever by a pivotal movement of the second magnetic body.

2. The integrated device of claim 1, wherein the first housing comprises:
a base plate of a predetermined area;
a case disposed on an upper surface of the base plate and configured with an open upper structure into which the parking button is inserted vertically; and
a guide plate disposed on the upper surface of the base plate, on first and second sides of the case, and having guide holes extending in a vertical direction thereof.

3. The integrated device of claim 2, further comprising:
a stopper disposed on at least one side of first and second sides of a lower portion of the parking button, configured to be inserted into the guide hole of the guide plate vertically, and including the first magnetic body.

4. The integrated device of claim 2,
wherein at least one first spring is connected between a lower surface of the parking button and the base plate, and
wherein the at least one first spring is compressed in response to a downward movement of the parking button.

5. The integrated device of claim 1, wherein the second housing includes hinge grooves on first and second sides of an upper portion of the second housing to allow the EPB lever to be pivotably mounted.

6. The integrated device of claim 5, wherein the EPB lever comprises:
a rectangular frame-shaped lever, including an operation bar disposed at a front position of the parking button and a push bar disposed to be in contact with a rear upper surface of the parking button; and
a pivot bar extending downwardly from at least one side of first and second sides of the lever, configured to be pivotably inserted into the hinge groove in a forward and backward direction, and including the second magnetic body.

7. The integrated device of claim 6, further comprising:
a second spring connected between an upper portion of the pivot bar and the hinge groove to provide an elastic restoring force in response to the pivoting of the EPB lever.

8. The integrated device of claim 6, wherein based on an upward operation of the operation bar of the EPB lever, the push bar presses the upper surface of the parking button, which limits a rotation angle of the EPB lever in an operation direction according to a pressing distance of the parking button, and based on an downward operation of the operation bar of the EPB lever, an internal surface of the operation bar comes into contact with a front portion of the parking button, which limits a rotation angle of the EPB lever in an operation release direction thereof.

9. The integrated device of claim 1, wherein the PCB comprises:
a first PCB including a first Hall sensor which is configured to detect a magnetic force based on the downward movement of the first magnetic body and to output an operation signal of the parking button; and
a second PCB including a second Hall sensor which is configured to detect a magnetic force based on a pivotal movement of the second magnetic body and to output an operation signal or operation release signal of the EPB lever.

10. The integrated device of claim 1, further comprising:
a lower cover covering a lower surface of the first housing and a peripheral portion of the second housing; and
an upper cover disposed on the lower cover and configured with an opening to operatively expose the parking button and the EPB lever externally.

11. An electrical parking brake (EPB) control system comprising:
a parking button pressably disposed on a first housing and including a first magnetic body mounted on at least one side of first and second sides thereof;
an EPB lever operatively disposed on a second housing spaced apart around a peripheral portion of the first housing, disposed around an upper peripheral portion of the parking button, and including a second magnetic body disposed on at least one side of first and second sides thereof;
a printed circuit board (PCB) disposed on a lower portion of the first housing and configured to detect an operation of the parking button by a downward movement of the first magnetic body and to detect an operation of the EPB lever by a pivotal movement of the second magnetic body;
a second controller configured to receive an operation signal of the parking button and an operation signal of the EPB lever from the PCB and to perform control to drive an EPB motor for an EPB braking operation; and
a first controller configured to receive an operation signal of the parking button and an operation signal of the EPB lever from the PCB, and to perform control to drive the EPB motor for the EPB braking operation, in preparation for a failure of the second controller.

12. The EPB control system of claim 11, wherein the PCB comprises:
a first PCB including a first Hall sensor that detects a magnetic force based on the downward movement of the first magnetic body and outputs an operation signal of the parking button to the first controller and the second controller; and
a second PCB including a second Hall sensor that detects a magnetic force based on a pivotal movement of the second magnetic body and outputs an operation signal or operation release signal of the EPB lever to the first controller and the second controller.

13. The EPB control system of claim 11, wherein the second controller is further configured to perform control to drive the EPB motor with a first torque based on receiving the operation signal of the EPB lever from the PCB, and to perform control to drive the EPB motor with a second torque lower than the first torque based on receiving the operation signal of the parking button from the PCB.

14. The EPB control system of claim 12, wherein the second controller is further configured to perform control to drive the EPB motor with a first torque based on the operation signal of the EPB lever in response to a failure of the parking button or the first PCB, and to perform control to drive the EPB motor with a second torque lower than the first torque based on the operation signal of the parking button in response to a failure of the EPB lever or the second PCB.

15. The EPB control system of claim 11, further comprising:
a third controller configured to either receive a control signal for driving the EPB motor based on the operation signal of the EPB lever from the first controller and perform control to drive a left-wheel EPB motor with a first torque, or receive a control signal for driving the EPB motor based on the operation signal of the parking button and perform control to drive the left-wheel EPB motor with a second torque lower than the first torque; and
a fourth controller configured to either receive a control signal for driving the EPB motor based on the operation signal of the EPB lever from the first controller and perform control to drive a right-wheel EPB motor with the first torque, or receive a control signal for driving the EPB motor based on the operation signal of the parking button and perform control to drive the right-wheel EPB motor with the second torque lower than the first torque.

16. An electrical parking brake (EPB) control method comprising:
pressing a parking button including a first magnetic body, or tilting an EPB lever including a second magnetic body in an operation direction or operation release direction;
detecting, by a printed circuit board (PCB), an operation of the parking button by a downward movement of the first magnetic body;
detecting, by the PCB, an operation of the EPB lever by a pivotal movement of the second magnetic body;
receiving, by a second controller, an operation signal of the parking button and an operation signal of the EPB lever from the PCB, and performing control to drive an EPB motor for an EPB braking operation; and
receiving, by a first controller, an operation signal of the parking button and an operation signal of the EPB lever from the PCB, and performing control to drive the EPB motor for the EPB braking operation, in preparation for a failure of the second controller.

17. The EPB control method of claim 16, wherein the PCB detects the operation of the parking button by detecting a magnetic force based on the downward movement of the first magnetic body and outputs the operation signal of the parking button to the first controller and the second controller, and detects the operation of the EPB lever by detecting a magnetic force based on the pivotal movement of the second magnetic body and outputs the operation signal or operation release signal of the EPB lever to the first controller and the second controller.

18. The EPB control method of claim 16, wherein the second controller is configured to perform control to drive the EPB motor with a first torque based on receiving the operation signal of the EPB lever from the PCB, and to perform control to drive the EPB motor with a second torque lower than the first torque based on receiving the operation signal of the parking button from the PCB.

19. The EPB control method of claim 17,
wherein the PCB includes a first PCB and a second PCB, and
wherein the second controller is configured to perform control to drive the EPB motor with the first torque based on the operation signal of the EPB lever in response to a failure of the parking button and the first PCB, and to perform control to drive the EPB motor with the second torque lower than the first torque based on the operation signal of the parking button in response to a failure of the EPB lever or the second PCB.

20. The EPB control method of claim 16, further comprising:
performing control, by a third controller, to drive a left-wheel EPB motor with a first torque by receiving a control signal for driving the EPB motor based on the operation signal of the EPB lever from the first controller, or performing control, by the third controller, to drive the left-wheel EPB motor with a second torque lower than the first torque by receiving a control signal for driving the EPB motor based on the operation signal of the parking button; and
performing control, by a fourth controller, to drive a right-wheel EPB motor with the first torque by receiving a control signal for driving the EPB motor based on the operation signal of the EPB lever from the first controller, or performing control, by the fourth controller, to drive the right-wheel EPB motor with the second torque lower than the first torque by receiving a control signal for driving the EPB motor based on the operation signal of the parking button.
